(19) United States
(12) Patent Application Publication
(10) Pub. No.: US 2015/0195179 A1
(43) Pub. Date: Jul. 9, 2015

(54) METHOD AND SYSTEM FOR CUSTOMIZING TOOLBAR BUTTONS BASED ON USAGE

(71) Applicants: Travis Michael Skare, Mountain View, CA (US); Allen Huang, Mountain View, CA (US); Aleksey Shlyapnikov, San Jose, CA (US)

(72) Inventors: Travis Michael Skare, Mountain View, CA (US); Allen Huang, Mountain View, CA (US); Aleksey Shlyapnikov, San Jose, CA (US)

(73) Assignee: Google Inc., Mountain View, CA (US)

(21) Appl. No.: 13/212,152

(22) Filed: Aug. 17, 2011

(51) Int. Cl. H04L 12/26; G06F 3/0484; G06F 11/30; G06F 9/445; G06F 9/44

(52) U.S. Cl. CPC H04L 43/16; G06F 8/65; G06F 8/71; G06F 11/3051; G06F 3/04842

(57) ABSTRACT

Systems, methods, and machine-readable media for determining a set of toolbar buttons to display on a toolbar is provided. The system may include a monitoring module, a configuration module, and a display module. The monitoring module may be configured to monitor usage of a plurality of features of the toolbar. The configuration module may be configured to determine a number of button positions on an updated toolbar based on the usage of the plurality of features and select a button to display for each button position of the number of button positions based on the usage of the plurality of features. The display module may be configured to display the button in the button position on the updated toolbar.

### BACKGROUND

The present disclosure generally relates to user interfaces and, in particular, to buttons on toolbars.

Toolbars for applications (e.g., a browser) often contain a number of buttons that may be used to perform one or more functions. The toolbars may be customized to include particular buttons by having a user locate a button the user wishes to add and placing it in an area of toolbar. Buttons may be removed by having a user select the button and, for example, right clicking the button and selecting a “remove button” option. Having buttons on the toolbar allows a user to quickly and conveniently locate buttons and activate them. However, manually adding and removing toolbar buttons requires effort and is time consuming. Furthermore, if too many buttons appear on a toolbar, the toolbar can become cluttered.

### SUMMARY

According to one aspect of the subject technology, a system for determining a set of toolbar buttons to display on a toolbar is provided. The system may include a monitoring module, a configuration module, and a display module. The monitoring module may be configured to monitor usage of a plurality of features of the toolbar. The configuration module may be configured to determine a number of button positions on an updated toolbar based on the usage of the plurality of features and select a button to display for each button position of the number of button positions based on the usage of the plurality of features. The display module may be configured to display the button in the button position on the updated toolbar.

According to another aspect of the subject technology, a method for determining a set of features to display on a toolbar is provided. The method may include monitoring usage of a plurality of features of the toolbar and receiving an update command to update the toolbar. In response to receiving the update command, the method may include determining a number of feature positions on an updated toolbar based on the usage of the plurality of features of the toolbar. The method may further include, for each feature position of the number of feature positions, selecting a feature to display in the feature position based on the usage of the plurality of features of the toolbar and providing the feature to be displayed in the feature position on the updated toolbar.

According to another aspect of the subject technology, a method for determining a set of toolbar buttons to display on a toolbar is provided. The method may include monitoring usage of a plurality of features of the toolbar and receiving an update command to update the toolbar. The method may further include, in response to receiving the update command, determining a number of button positions on an updated toolbar based on the usage of the plurality of features and selecting, for each button position of the number of button positions, a button to display in the button position based on the usage of the plurality of features. The method may also include displaying the button in the button position on the updated toolbar.

According to yet another aspect of the subject technology, a machine-readable medium including instructions stored therein, which when executed by a machine, cause the machine to perform operations for determining a set of toolbar buttons to display on a toolbar is provided. The operations may include generating usage report containing usage data for a plurality of buttons of the toolbar and determining a number of button positions on an updated toolbar based on the usage report. For each button position of the number of button positions, a button may be selected to be display in the button position based on the usage report. The operations further include displaying the selected buttons in their button positions on the updated toolbar.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding of the subject technology and are incorporated in and constitute a part of this specification, illustrate disclosed aspects of the subject technology and together with the description serve to explain the principles of the subject technology.

FIG. 1 is a conceptual block diagram illustrating an environment for customizing toolbar buttons in accordance with various aspects of the subject technology.

FIG. 2 is a flow chart illustrating a process for customizing toolbar buttons in accordance with various aspects of the subject technology.

FIG. 3 is a conceptual representation of a user interface in accordance with various aspects of the subject technology.

FIG. 4 is a conceptual representation of a user interface that illustrates a number of button positions in accordance with various aspects of the subject technology.

FIG. 5 is a conceptual representation of a user interface that illustrates buttons displayed in their respective button positions in accordance with various aspects of the subject technology.

FIG. 6 is a conceptual representation of a user interface that illustrates a menu button in accordance with various aspects of the subject technology.

FIG. 7 is a block diagram illustrating a computer system with which any of the clients and servers of FIG. 1 may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology.

In accordance with various aspects of the subject technology, systems and methods for customizing buttons on a toolbar are disclosed. In accordance with various aspects of the subject technology, the usage of toolbar features (e.g., buttons on the toolbar) may be monitored in order to generate usage data on the toolbar features. The usage data may include, for example, which features were or were not used during a particular period of time (e.g., the past two weeks), how many times each feature was used during the period of time, the least recently used feature, the most recently used feature, the rate at which each feature is used, etc. The usage data for the toolbar features may be used to determine how many button positions are displayed on the toolbar and which buttons are displayed in the button positions. In some aspects, the usage data may be used to determine which buttons may be removed from the visible portion of the toolbar.

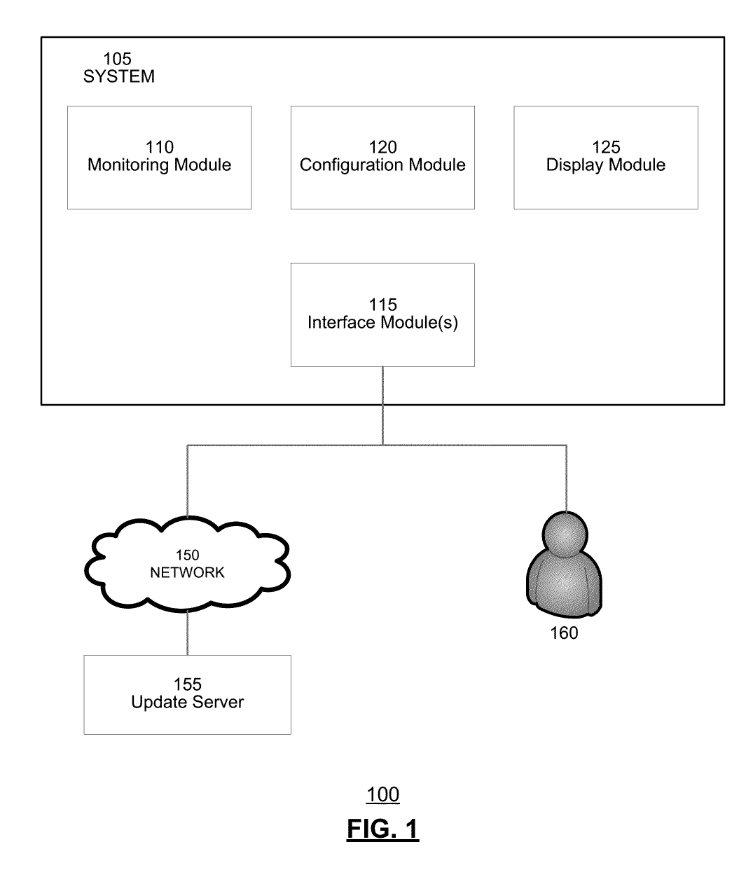

FIG. 1 is a conceptual block diagram illustrating an environment 100 in which a system 105 may customize toolbar buttons, in accordance with various aspects of the subject technology. The system 105 (e.g., a computing device, a mobile device, etc.) may include a number of applications that have user interfaces that include toolbars. Some applications may include, for example, browser applications, image editing applications, document reading applications, operating system user interfaces, etc. Some web pages that may be displayed in browser applications may also include toolbar interfaces.

A toolbar (e.g., toolbar interfaces) may be any user interface component that contains buttons. The buttons may be located at button positions on the toolbar and may be configured to perform a wide variety of actions. For example, a button may be configured to activate a certain feature of the application, to open up another user interface, or to open another application. The buttons may be provided by the application itself or by third-parties creating a button for the application.

The system 105 may include a monitoring module 110, one or more interface modules 115, a configuration module 120, and a display module 125. The monitoring module 110 may be configured to monitor the usage of toolbar features (e.g., the usage of buttons associated with the toolbar). For example, the monitoring module 110 may detect when a user selects a button associated with one or more features of the toolbar (e.g., a button or icon displayed on the toolbar or accessible through another toolbar interface element) and record when the button was selected in a usage report. In other aspects, the monitoring module 110 may detect when a user selects a button associated with a toolbar feature and increment a count associated with the button or the toolbar feature in the usage report. The usage report may also include information about which buttons or toolbar features were used in a particular period (e.g., the past 2 weeks, in January 2011, etc.), the number of times each button or toolbar feature was used during the particular period, the rate at which each button or toolbar feature was used, etc.

The one or more interface modules 115 may be configured to receive an update command that signals the system 105 to update the toolbar. The update command may be received from a user 160 via one or more input/output devices (e.g., a keyboard and mouse), from an update server 155 via a network 150 (e.g., the internet), or from the system 105 itself (e.g., the system 105 may periodically attempt to update the toolbar or check for updates). In some aspects, upon receiving the update command, the interface module 115 may attempt to retrieve one or more installation files containing data that is to be used to update the toolbar. The installation files may be obtained from a secondary storage device (e.g., a compact disc or external memory device) or from the update server 155 over the network 150.

The configuration module 120 may update the application associated with the toolbar or only the toolbar itself using the installation files retrieved by the interface module 115. The configuration module 120 may also determine the number of button positions to be displayed on the updated toolbar based on the usage information for the buttons on the toolbar stored in the usage report. The number of button positions to be displayed on the updated toolbar may be based on, for example, the number of buttons used within a predetermined period of time before the update command was received by the interface module 115. In another aspect, the number of button positions may also be based on the number of buttons that have been used over a threshold number of times within a defined period of time.

The configuration module 120 may also be configured to select which buttons are to be displayed in the button positions. The buttons selected to be displayed may be, for example, one of the buttons that were used during the predetermined period of time or one of the buttons used over the threshold number of times. In some aspects, the buttons selected to be displayed may be buttons associated with toolbar features that were used during the predetermined period of time or one of the toolbar features used over the threshold number of times. The order in which the buttons are displayed may also be determined by the configuration module 120 based on, for example, the number of times each button was used (e.g., the most used button may be displayed in the first button position, the second most used button may be displayed in the second button position, and so on).

After the buttons to be displayed on the toolbar are identified, the display module may be configured to display the identified buttons in the appropriate button positions on the updated toolbar. In some aspects, the number of buttons displayed on the updated toolbar is reduced compared to the number of buttons displayed on the earlier version of the toolbar. By removing certain buttons from the toolbar, the updated toolbar may provide a less cluttered user interface where a user may more easily identify a desired button. Furthermore, the buttons that are most used or most recently used by the user may be displayed on the updated toolbar instead of buttons that are used less often. As a result, users may be able to conveniently locate the buttons that are most often used on the toolbar while other buttons may be displayed on another user interface (e.g., a menu interface) that may be accessed from the toolbar.

After the toolbar is updated with a number of button positions and the particular buttons identified by the configuration module 120, the monitoring module 110 may continue to monitor the usage of buttons associated with the toolbar and the configuration module 120 may update the buttons displayed in the button positions of the toolbar. For example, if the monitoring module 110 detects a user activation (e.g., a user selection) of one of the buttons not displayed on the updated toolbar, the system may identify the least recently used button displayed in one of the button positions of the toolbar and replace the button with the recently activated button. In some aspects, the button positions of the toolbar may resemble a most recently used list where the first button position displays the most recently used button, the second button position displays the second most recently used button, and so on. In this way, the toolbar may be configured to display the most recently used buttons.

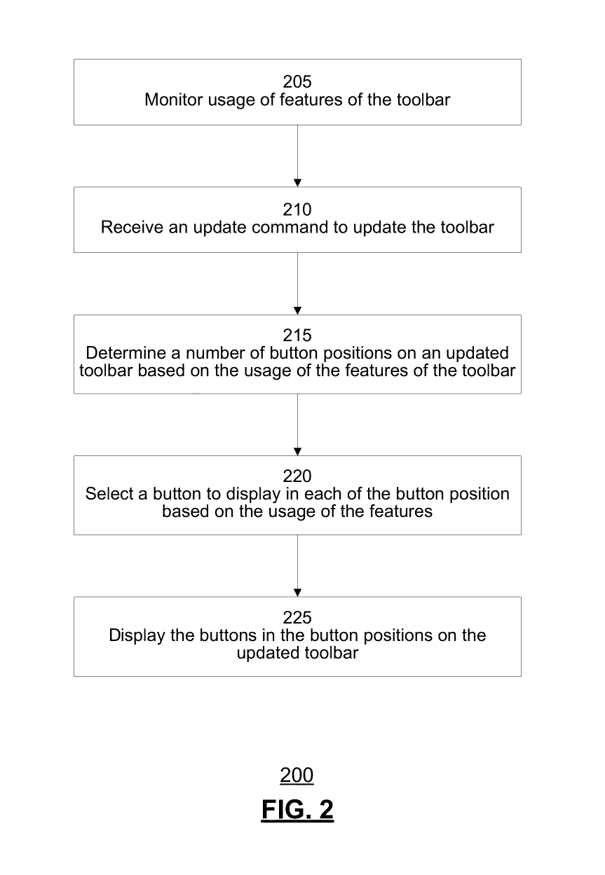

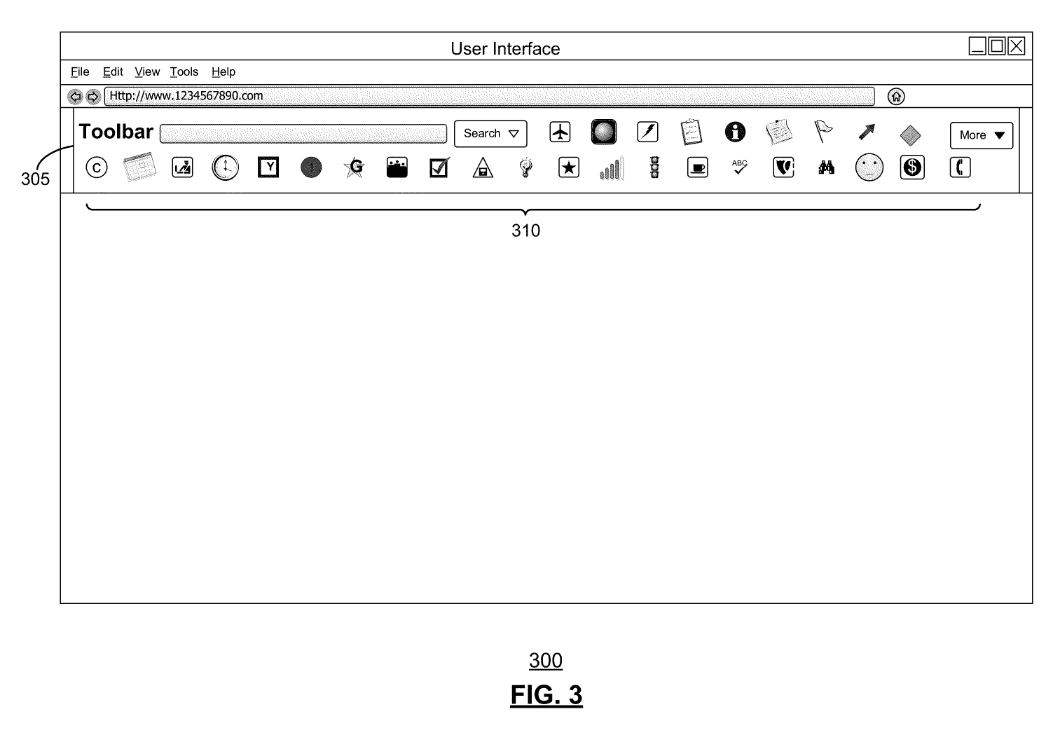

FIG. 2 is a flow chart illustrating a process 200 for customizing toolbar buttons in accordance with various aspects of the subject technology. Although the operations in process 200 are shown in a particular order, certain operations may be performed in different orders or at the same time. The process 200 may begin at operation 205, where the monitoring module 110 monitors the usage of the toolbar features. The user interface displayed in FIG. 3 may help to illustrate how the buttons of the toolbar are monitored.

FIG. 3 is a conceptual representation of a user interface 300 in accordance with various aspects of the subject technology. The user interface 300 may be associated with various application (e.g., a web browser) that uses a toolbar 305. Although the toolbar of FIG. 3 is located at the top of the user interface 300, in other aspects, the toolbar 305 may be located at the bottom of the interface 300, the side of the interface 300, or any other location (e.g., a floating toolbar).

The toolbar may display various interface components such as a search bar, one or more menus, and a number of buttons 310. The monitoring module 110 may monitor button usage by detecting and recording user activation of the buttons 310 in the toolbar 305. The monitoring module 110 may store usage data for the buttons in, for example, a usage report that may include, for example, which buttons were used, what features those buttons are associated, when they were used, how many times each button or feature was used during a given period, etc. In some aspects, the usage report may include a count associated with a feature and each time a particular button is activated, the monitoring module 110 may determine which feature the activated button is associated with and increment the count associated with that feature.

Instead of displaying a multitude of buttons 310, the system may remove certain buttons from the visible portion of the toolbar 305 and display other buttons based on the usage data for the features and buttons. In some aspects, the system may be configured to customize the buttons on the toolbar in response to an update command. For example, referring back to FIG. 2, an interface module 115 may receive an update command from an update server 155 or a user 160 at operation 210. This may occur when the user downloads an installer for a new version of the toolbar or the application associated with the toolbar and executes the installer. In other aspects, the toolbar may connect to the update server 155 (either periodically or when directed by the user) in order to check to see if there is a new version and initiate an update if there is a new version.

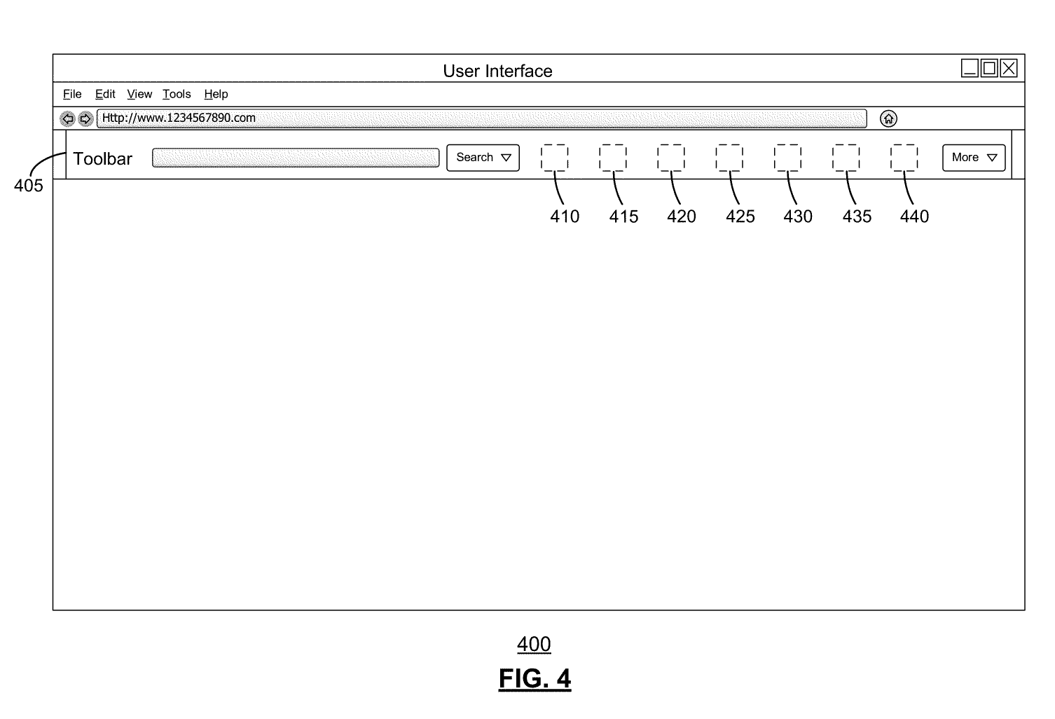

In response to receiving the update command, the configuration module 120 may analyze the usage data generated by the monitoring module 110 and determine how many button positions to display on the updated toolbar. FIG. 4 is a conceptual representation of a user interface 400 that illustrates a number of button positions in accordance with various aspects of the subject technology. The user toolbar 405 in user interface 400 includes a number of button positions 410, 415, 420, 425, 430, 435, and 440.

The number of button positions on the updated toolbar 405 may be based on the number of distinct features (e.g., buttons) used over a particular period (e.g., the past 2 weeks, since the last toolbar update, since the last usage reporting period, etc.), the number of distinct features (e.g., buttons) that were used at least a threshold number of times (e.g., 5 times) in a given period of time, or the number of features (e.g., buttons) that were used over a threshold rate (e.g., 2 times a day). In some aspects, the configuration module 120 may identify a minimum number of button positions (e.g., 4 button positions) such that if not enough features meet the requirements, the configuration module 120 may provide the minimum number of button positions on the updated toolbar 405.

Referring back to FIG. 2, the configuration module 120 may also select a button to be displayed in each of the button positions of the toolbar at operation 220. The selection of the buttons may also be based on how the number of button positions was determined. For example, if the number of button positions is equal to the number of distinct features used during a particular period, the buttons selected to appear in those positions may be buttons associated with those features that were used during the period. If the number of button positions is equal to the number of features that were used more than a threshold number of times, the buttons selected to appear in those positions may be buttons associated with the features that were used more than the threshold number of times. If the configuration module 120 determines the number of button positions to be equal to the number of distinct buttons used during a particular period rather than the number of distinct features, the buttons selected to appear in those positions may be those buttons that were used during the period.

The selected buttons may also be assigned to button positions based on, for example, how recently each feature or button was used. For example, in FIG. 4, the first button position 410 may be assigned a button associated with the feature that was most recently used, while the second button position 415 may be assigned a button associated with the feature that was the next most recently used, and so on. The buttons may also be assigned based on the number of times the features or buttons were used during a particular period. For example, in FIG. 4, the first button position 410 may be assigned a button associated with the feature that was used the most, while the second button position 415 may be assigned a button associated with the feature that was used the second most, and so on.

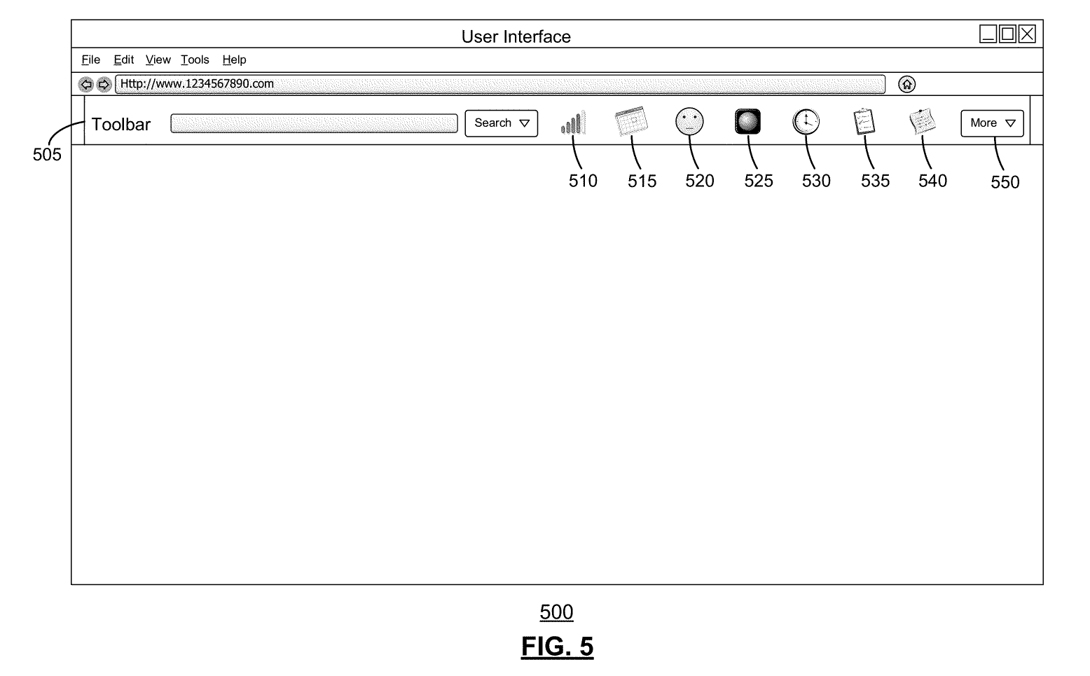

Referring back to FIG. 2, after the button positions are assigned buttons, at operation 225, the display module 125 may display the buttons in their respective button positions on the updated toolbar. For example, FIG. 5 is a conceptual representation of a user interface 500 that illustrates buttons displayed in their respective button positions in accordance with various aspects of the subject technology. The user interface 500 includes a toolbar 505 that displays buttons 510, 515, 520, 525, 530, 535, and 540 in their respective button positions.

The buttons 510, 515, 520, 525, 530, 535, and 540 may have been selected out of all the buttons associated with the toolbar 505 and arranged on the toolbar 505 based on their usage data. Each of the buttons 510, 515, 520, 525, 530, 535, and 540 may have been used during a particular period of time or used over a threshold number of times over a period of time, for example. The buttons associated with the toolbar 505 that are not visibly displayed in one of the button positions of the toolbar 505 may be accessed through a separate menu button 550 that displays the additional buttons in a separate user interface component.

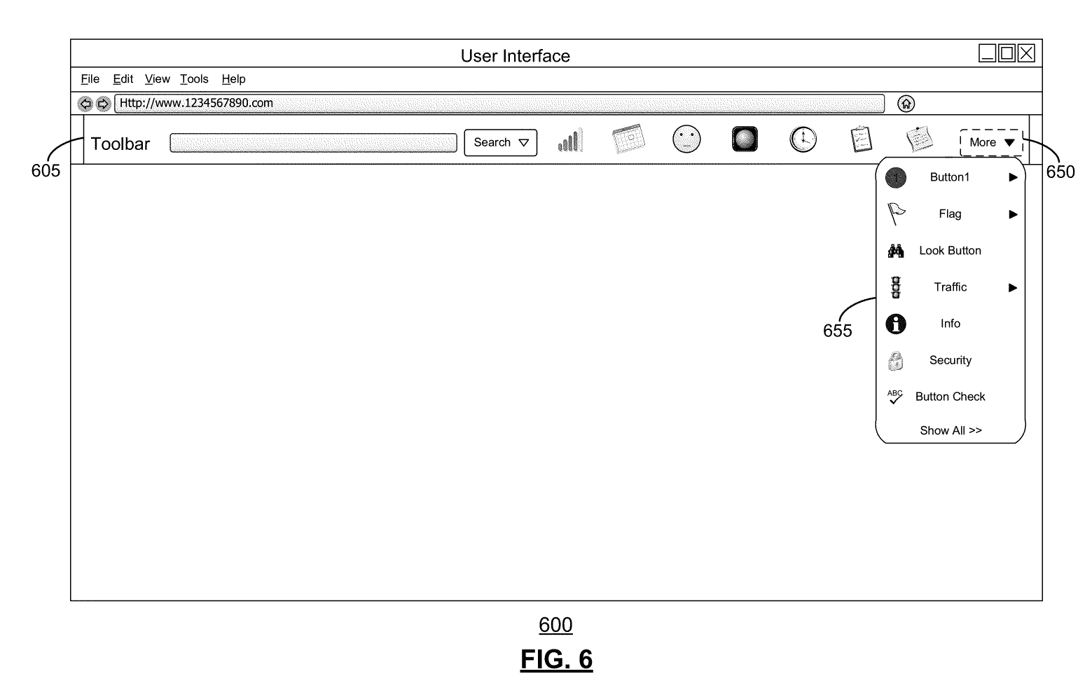

FIG. 6 is a conceptual representation of a user interface 600 that illustrates a menu button 650 in accordance with various aspects of the subject technology. In FIG. 6, the menu button 650 on the toolbar 605 has been activated by a user and, as a result, a separate user interface component 655 is displayed containing additional buttons associated with the toolbar 605. The buttons shown in user interface component 655 may not have been selected to be displayed in on of the button positions of the toolbar 605 because they, for example, were not used during a particular period or they were not used over a threshold number of times in a given period. The menu button 650, however, enables a user to conveniently locate these buttons.

In some aspects, the buttons positions of the toolbar may act as an ordered list of the most recently used buttons. For example, the monitoring module 110 may detect an activation of one of the buttons associated with the toolbar (e.g., from one of the button positions or from the user interface component 655), the configuration module 120 may assign the activated button to the first button position, and the display module 125 may display the activated button in the first button position of the toolbar. The button that was formerly displayed in the first button position may be moved to the second button position, the button formerly displayed in the second button position may be moved to the third button position, and so on. The button displayed in the last button position may be removed from the button positions on the toolbar and may be accessed in the future through the menu button 650 and the user interface component 655.

In another aspect, the button positions of the toolbar may act as an ordered list of the most used buttons where the first button position displays the button that has been used the most over a particular period of time, the second button position displays the button that has been used the second most over the period of time, and so on.

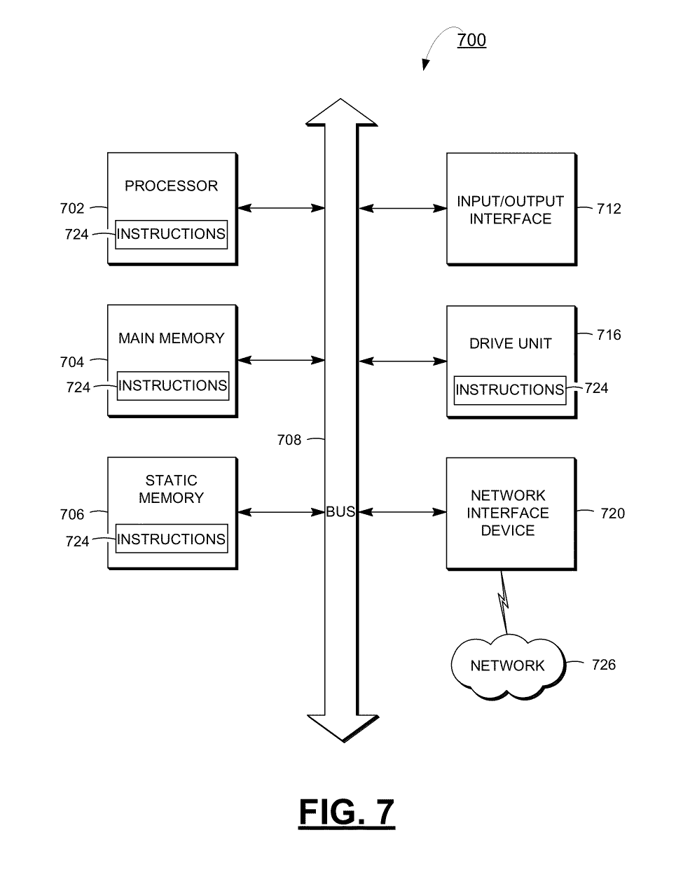

FIG. 7 is a block diagram illustrating a computer system with which any of the clients and servers of FIG. 1 may be implemented. In certain aspects, the computer system 700 may be implemented using hardware or a combination of software and hardware, either in a dedicated server, or integrated into another entity, or distributed across multiple entities.

The example computer system 700 includes a processor 702, a main memory 704, a static memory 706, a disk drive unit 716, and a network interface device 720 which communicate with each other via a bus 708. The computer system 700 may further include an input/output interface 712 that may be configured to communicate with various input/output devices such as video display units (e.g., liquid crystal (LCD) displays, cathode ray tubes (CRTs), or touch screens), an alphanumeric input device (e.g., a keyboard), a cursor control device (e.g., a mouse), or a signal generation device (e.g., a speaker).

Processor 702 may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

A machine-readable medium (also referred to as a computer-readable medium) may store one or more sets of instructions 724 embodying any one or more of the methodologies or functions described herein. The instructions 724 may also reside, completely or at least partially, within the main memory 704 and/or within the processor 702 during execution thereof by the computer system 700, with the main memory 704 and the processor 702 also constituting machine-readable media. The instructions 724 may further be transmitted or received over a network 726 via the network interface device 720.

The machine-readable medium may be a single medium or multiple media (e.g., a centralized or distributed database, and/or associated caches and servers) that store the one or more sets of instructions. The machine-readable medium may include the drive unit 716, the static memory 706, the main memory 704, the processor 702, an external memory connected to the input/output interface 712, or some other memory. The term “machine-readable medium” shall also be taken to include any non-transitory medium that is capable of storing, encoding or carrying a set of instructions for execution by the machine and that cause the machine to perform any one or more of the methodologies of the embodiments discussed herein. The term “machine-readable medium” shall accordingly be taken to include, but not be limited to, storage mediums such as solid-state memories, optical media, and magnetic media.

Systems, methods, and machine-readable media for customizing buttons on a toolbar are disclosed. In accordance with various aspects of the subject technology, the usage of buttons on the toolbar may be monitored in order to generate usage data on the buttons. The usage data may include, for example, which buttons were or were not used during a particular period of time (e.g., the past two weeks), how many times each button was used during the period of time, the least recently used button, the most recently used button, the rate at which each button is used, etc. The usage data for the buttons may be used to determine how many button positions are displayed on the toolbar and which buttons are displayed in the button positions. In some aspects, the usage data may be used to determine which buttons may be removed from the visible portion of the toolbar.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” may be used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

1. A method for determining a set of features to display on a toolbar, the method comprising:
monitoring usage of a plurality of features of the toolbar for a first version of an application;
receiving an update command to install a second version of the application, the second version of the application being an updated installation of the application and comprising an updated toolbar;
determining a number of feature positions to be displayed on the updated toolbar for the second version of the application, wherein the number of feature positions is determined based on the usage of the plurality of features of the toolbar for the first version of the application; and
for each feature position of the number of feature positions:
selecting a feature to display in the feature position based on the usage of the plurality of features of the toolbar for the first version of the application, and
providing the feature to be displayed in the feature position on the updated toolbar for the second version of the application.

2. The method of claim 1, wherein the number of feature positions on the updated toolbar for the second version of the application is less than or equal to the number of features on the toolbar for the first version of the application.

3. The method of claim 1, wherein the determining of the number of feature positions on the updated toolbar comprises:
determining the number of features used within a predetermined period of time; and
wherein the number of feature positions on the updated toolbar equals the number of features used within the predetermined period of time.

4. The method of claim 1, wherein the determining of the number of feature positions on the updated toolbar comprises:
determining the number of features used at least a threshold number of times within a predetermined period of time;
wherein the number of feature positions on the updated toolbar equals the number of features used at least the threshold number of times within the predetermined period of time.

5. The method of claim 1, wherein the number of feature positions on the updated toolbar is a default number of positions.

6. The method of claim 1, further comprising:
arranging the selected features in the feature positions based on the number of times each feature was used during a predetermined time period.

7. The method of claim 6, wherein the selected features are arranged in a way that the selected feature used the most during the predetermined time period is displayed in the left most feature position on the updated toolbar and the selected feature used the least during the predetermined time period is displayed in the right most feature position on the updated toolbar.

8. The method of claim 1, further comprising:
arranging the selected features in the feature positions based on how recently each of the selected features was used.

9. The method of claim 8, wherein the selected features are arranged in a way that the most recently used feature appears in the left most button position on the updated toolbar and the least recently used selected feature appears in the right most feature position on the updated toolbar.

10. The method of claim 1, wherein the monitoring of the usage of the plurality of features of the toolbar for the first version of the application comprises:
detecting a selection of a feature of the plurality of features; and
incrementing a count for the feature associated with the feature in a usage report.

11. The method of claim 1, further comprising:
detecting a feature activation of a feature not displayed in the feature positions;
removing a least recently used feature from display in one of the feature positions; and
displaying the activated feature in one of the feature positions.

12. The method of claim 1, further comprising displaying a menu feature that, when selected, displays a user interface component comprising features that are not displayed in the feature positions displayed on the updated toolbar.

13. The method of claim 1, wherein the feature to be displayed in the feature position on the updated toolbar is a button.

14. A method for determining a set of toolbar buttons to display on a toolbar, the method comprising:
monitoring usage of a plurality of features of the toolbar for a first version of an application;
receiving an update command to install a second version of the application, the second version of the application being an updated installation of the application and comprising an updated toolbar;
determining a number of button positions to be displayed on the updated toolbar for the second version of the application, wherein the number of button positions is determined based on the usage of the plurality of features of the toolbar for the first version of the application; and
for each button position of the number of button positions:
selecting a button to display in the button position based on the usage of the plurality of features of the toolbar for the first version of the application, and
providing the button to be displayed in the button position on the updated toolbar for the second version of the application.

15. The method of claim 14, further comprising:
arranging the selected buttons in the button positions based on the number of times each feature was used during a predetermined time period; and
wherein the selected buttons are arranged in a way that the selected button associated with the feature used the most during the predetermined time period is displayed in the left most button position on the updated toolbar and the selected button associated with the button used the least during the predetermined time period is displayed in the right most button position on the updated toolbar.

16. The method of claim 14, further comprising:
arranging the selected buttons in the button positions based on how recently each of the features associated with the selected buttons were used; and
wherein the selected buttons are arranged in a way that the selected button associated with the most recently used feature appears in the left most button position on the updated toolbar and the selected button associated with the least recently used selected feature appears in the right most button position on the updated toolbar.

17. The method of claim 14, wherein the monitoring of the usage of the plurality of features of the toolbar for the first version of the application comprises:
detecting a selection of a button of the plurality of buttons, wherein the button is associated with a feature of the toolbar for the first version of the application; and
incrementing a count for the feature associated with the button in a usage report.

18. A system for determining a set of toolbar buttons to display on a toolbar, the system comprising:
a monitoring module configured to monitor usage of a plurality of features of the toolbar for a first version of an application;
an interface module configured to receive an update command to install a second version of the application, the second version of the application being an updated installation of the application and comprising an updated toolbar;
a configuration module configured to:
determine a number of button positions on the updated toolbar based on the usage of the plurality of features, and
select a button to display for each button position of the number of button positions based on the usage of the plurality of features; and
a display module configured to provide the selected buttons for display in the button positions of the updated toolbar for the second version of the application.

19. (canceled)

20. The system of claim 18, wherein the configuration module is configured to determine the number of positions on the updated toolbar by:
determining the number of features used within a predetermined period of time; and
wherein the number of positions on the updated toolbar equals the number of features used within the predetermined period of time.

21. The system of claim 18, wherein the configuration module is configured to determine the number of positions on the updated toolbar by:
determining the number of features used at least a threshold number of times within a predetermined period of time;
wherein the number of positions on the updated toolbar equals the number of features used at least the threshold number of times within the predetermined period of time.

22. The system of claim 18, wherein the configuration module is further configured to:
arrange the selected buttons in the button positions based on how recently each of the features associated with the selected buttons were used.

23. The system of claim 22, wherein the selected buttons are arranged in a way that the selected button associated with the feature used the most during the predetermined time period is displayed in the left most button position on the updated toolbar and the selected button associated with the feature used the least during the predetermined time period is displayed in the right most button position on the updated toolbar.

24. The system of claim 18, wherein the configuration module is further configured to: arrange the selected buttons in the button positions based on the number of times each feature was used during a predetermined time period.

25. The method of claim 24, wherein the selected buttons are arranged in a way that the selected button associated with the most recently used feature appears in the left most button position on the updated toolbar and the selected button associated with the least recently used feature appears in the right most button position on the updated toolbar.

26. The system of claim 18, wherein the monitoring module is configured to monitor the usage of the plurality of buttons of the toolbar for the first version of the application by:
detecting a selection of a button of the plurality of buttons, wherein the button is associated with a feature of the toolbar for the first version of the application; and
incrementing a count for the feature associated with the button in a usage report.

27. A machine-readable medium comprising instructions stored therein, which when executed by a machine, cause the machine to perform operations comprising:
generating usage report containing usage data for a plurality of buttons of a toolbar for a first version of an application;
receiving an update command to install a second version of the application, the second version of the application being an updated installation of the application and comprising an updated toolbar;
determining a number of button positions on the updated toolbar for the second version of the application, wherein the number of feature positions is determined based on the usage report; and
for each button position of the number of button positions, selecting a button to display in the button position based on the usage report; and
displaying the selected buttons in their button positions on the updated toolbar for the second version of the application.

28. (canceled)

29. The machine-readable medium of claim 27, wherein the determining of the number of positions on the updated toolbar comprises:
determining, using the usage report, the number of buttons used within a predetermined period of time; and
wherein the number of positions on the updated toolbar equals the number of buttons used within the predetermined period of time.

30. The machine-readable medium of claim 27, the operations further comprising:
arranging the selected buttons in the button positions based on how recently each button was used.
